(19) United States
(12) Patent Application Publication
(10) Pub. No.: US 2025/0062610 A1
(43) Pub. Date: Feb. 20, 2025

(54) APPARATUS, SYSTEM, AND METHOD OF CURRENT CONSUMPTION ADJUSTMENT

(71) Applicant: INTEL CORPORATION, Santa Clara, CA (US)

(72) Inventors: Harel Aronheim, Giv'atayim (IL); Dmitry Felsenstein, Gan-Yavne (IL); Ariel Wolf, Haifa (IL); Eran Amir, Givat Ada (IL); Ofir Klein, Petah Tikva (IL); Yazan Alwilly, Majdal shams (IL); Sergey Sofer, Rishon Lezion (IL); Sagi Belizowski, Haifa (IL)

(73) Assignee: INTEL CORPORATION, Santa Clara, CA (US)

(21) Appl. No.: 18/399,290

(22) Filed: Dec. 28, 2023

Related U.S. Application Data
(60) Provisional application No. 63/520,183, filed on Aug. 17, 2023.

(51) Int. Cl. H02J 1/14

(52) U.S. Cl. CPC H02J 1/14

(57) ABSTRACT

For example, a current consumption adjuster may be configured to adjust a current consumption from a power supply of an integrated circuit. For example, the current consumption adjuster may include a controllable load circuitry to controllably apply one or more loads to the power supply of the integrated circuit. For example, the current consumption adjuster may include a controller configured to identify a current consumption event including a transition of a current consumption of the integrated circuit from the power supply. For example, the controller may be configured to control activation of the controllable load circuitry to apply an event-based load to the power supply, for example, based on the current consumption event.

### CROSS REFERENCE

This application claims the benefit of and priority from U.S. Provisional Patent Application No. 63/520,183 entitled “APPARATUS, SYSTEM, AND METHOD OF CURRENT CONSUMPTION ADJUSTMENT”, filed Aug. 17, 2023, the entire disclosure of which is incorporated herein by reference.

### BACKGROUND

A Power Distribution Network (PDN) may be utilized to provide power to electrical components of Integrated Circuits (IC).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of an apparatus, in accordance with some demonstrative aspects.

FIG. 2 is a schematic block diagram illustration of an apparatus, in accordance with some demonstrative aspects.

FIG. 3 is a schematic illustration of a graph depicting an artificial load current configured based on a current consumption of circuitry, in accordance with some demonstrative aspects.

FIG. 4 is a schematic illustration of load circuitry, in accordance with some demonstrative aspects.

FIG. 5 is a schematic illustration of a load current pattern of load circuitry, in accordance with some demonstrative aspects.

FIG. 6 is a schematic flow-chart illustration of a method of current consumption adjustment, in accordance with some demonstrative aspects.

FIG. 7 is a schematic timing diagram depicting an artificial load current configured based on a current consumption of transmit circuitry, in accordance with some demonstrative aspects.

FIG. 8A is a schematic illustration of a graph depicting voltage and current versus time for wireless transmission circuitry, and FIG. 8B is a schematic illustration of a graph depicting voltage and current versus time for the wireless transmission circuitry subject to an artificial load, in accordance with some demonstrative aspects.

FIG. 9 is a schematic illustration of a device, in accordance with some demonstrative aspects.

FIG. 10 is a schematic flow-chart illustration of a method of current consumption adjustment, in accordance with some demonstrative aspects.

FIG. 11 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Bluetooth (BT) device, a Bluetooth Low Energy (BLE) device, an audio device, a video device, an audio (A/V) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020), and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, wireless communication systems, cellular radio-telephone communication systems, a mobile phone, a cellular telephone, a wireless telephone, a Bluetooth system, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), Extended GPRS, Code-Division Multiple Access (CDMA), Wideband CDMA (WCDMA), CDMA 2000, single-carrier CDMA, multi-carrier CDMA, Multi-Carrier Modulation (MCM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network, and/or a cellular network, e.g., a 5G network. Other aspects may be used in conjunction with any other suitable wireless communication network, for example, a wireless area network, a “piconet”, a WPAN, a WVAN, and the like.

Some demonstrative aspects may be used in conjunction with a wireless communication network communicating over a frequency band of 2.4 GHz, 5 GHz, or 6 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

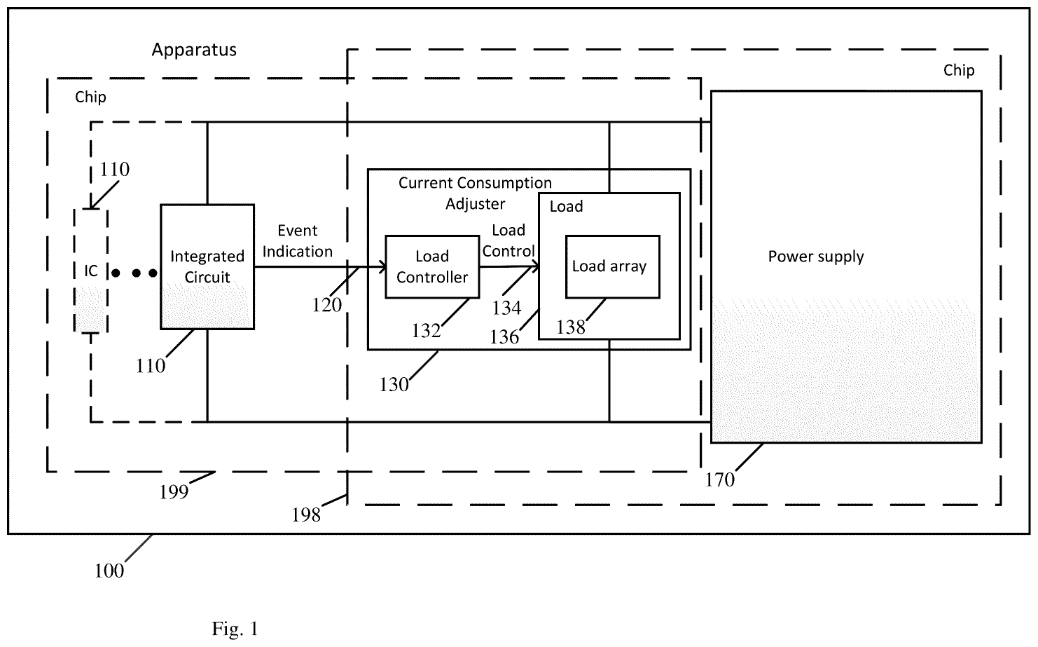

Reference is made to FIG. 1, which schematically illustrates an apparatus 100, in accordance with some demonstrative aspects.

In some demonstrative aspects, apparatus 100 may include, or may be implemented as part of, a computing device, e.g., as described below.

In some demonstrative aspects, apparatus 100 may include, or may be implemented as part of, a communication device, for example, a wireless communication device, e.g., as described below.

In some demonstrative aspects, apparatus 100 may include, or may be implemented as part of, a communication interface, for example, a wireless communication interface, e.g., as described below.

In some demonstrative aspects, apparatus 100 may include, or may be implemented as part of, a transmitter, for example, a wireless transmitter, e.g., as described below.

In some demonstrative aspects, apparatus 100 may include, or may be implemented as part of, a receiver, for example, a wireless receiver, e.g., as described below.

In some demonstrative aspects, apparatus 100 may include, or may be implemented as part of, a processor, e.g., as described below.

In some demonstrative aspects, apparatus 100 may include, or may be implemented as part of, a wireless communication processor, e.g., as described below.

In some demonstrative aspects, apparatus 100 may include, or may be implemented as part of, an accelerator, e.g., as described below.

In some demonstrative aspects, apparatus 100 may include, or may be implemented as part of, any other device, element and/or component, e.g., as described below.

In some demonstrative aspects, as shown in FIG. 1, apparatus 100 may include one or more integrated circuits (ICs) 110, e.g., as described below.

In some demonstrative aspects, the one or more integrated circuits 110 may include one or more digital ICs and/or any other ICs, e.g., as described below.

In some demonstrative aspects, apparatus 100 may include one or more Very large-scale integration (VLSI) ICs, for example, including the one or more ICs 110, e.g., as described below.

In some demonstrative aspects, integrated circuit 110 may include, or may be implemented as part of, a VLSI circuit, e.g., as described below.

In other aspects, the one or more integrated circuits 110 may include any other type of ICs and/or may be implemented as part of any other circuitry and/or according to any other IC architectures and/or technologies.

In some demonstrative aspects, as shown in FIG. 1, apparatus 100 may include, or may be associated with, at least one power supply 170 to provide power to the integrated circuits 110, e.g., as described below.

In some demonstrative aspects, as shown in FIG. 1, the power supply 170 may include, for example, a power supply converter, e.g., a switching converter or a linear converter, for example, with an output capacitor and an input capacitor, e.g., as described below.

In some demonstrative aspects, the power supply 170 may be implemented as an internal power supply, which may be integrated with the integrated circuits 110, e.g., as part of the IC die, or as an external power supply, e.g., external to the IC die.

In one example, the power supply 170 may be implemented with the integrated circuits 110 according to a System on Chip (SOC) integration level, e.g., on the same IC die of integrated circuits 110.

In another example, the power supply 170 may be implemented with the integrated circuits 110 according to a System in Package (SiP) integration level, e.g., on a same package.

In another example, the power supply 170 may be implemented with the integrated circuits 110 according to a module integration level, e.g., on a same PCB.

In another example, the power supply 170 may be implemented with the integrated circuits according to any other suitable architecture and/or integration level.

In some demonstrative aspects, one or more integrated circuits 110 of apparatus 100 may be configured to perform one or more operations and/or functionalities, which may be subject to, and/or characterized by, changes in current consumption, e.g., as described below.

In some demonstrative aspects, apparatus 100 may include one or more digital ICs 110, e.g., as described below.

In some demonstrative aspects, the digital ICs 110 may include, for example, any suitable digital Intellectual Property (IP) IC, a processor IC, an accelerator IC, and/or any other type of IC.

In some demonstrative aspects, the digital ICs 110 may consume relatively high accumulated currents, for example, at one or more types of instant current demand events, e.g., as described below.

In some demonstrative aspects, for example, apparatus 100 may include, or may be implemented as part of, a wireless communication apparatus, e.g., as described below.

In some demonstrative aspects, apparatus 100 may include, or may be implemented as part of, a wireless communication interface, for example, a wireless communication modem, which may be configured to perform one or more operations to communicate wireless communication transmissions.

In some demonstrative aspects, apparatus 100 may include, or may be implemented as part of, a wireless communication radio, e.g., as described below.

In some demonstrative aspects, apparatus 100 may include, or may be implemented as part of, a wireless communication receiver including circuitry and/or logic to receive wireless communication signals, RF signals, frames, blocks, transmission streams, packets, messages, data items, and/or data, e.g., as described below.

In some demonstrative aspects, apparatus 100 may include, or may be implemented as part of, a wireless communication transmitter including circuitry and/or logic to transmit wireless communication signals, RF signals, frames, blocks, transmission streams, packets, messages, data items, and/or data, e.g., as described below.

In some demonstrative aspects, integrated circuit 110 may include a wireless communication integrated circuit, which may be configured to process communication of wireless communication signals, e.g., as described below.

In some demonstrative aspects, integrated circuit 110 may include a transmitter integrated circuit, e.g., which may be configured to process transmission of a wireless communication signal, e.g., as described below.

In some demonstrative aspects, integrated circuit 110 may include a receiver integrated circuit, which may be configured to process reception of a wireless communication signal, e.g., as described below.

In other aspects, integrated circuit 110 may include any other additional or alternative type of wireless communication integrated circuit, which may be configured to perform any other additional or alternative wireless communication functionalities.

In some demonstrative aspects, integrated circuit 110 may include a processor integrated circuit, which may be configured to perform one or more functionalities of a processor, e.g., as described below.

In some demonstrative aspects, integrated circuit 110 may include an accelerator integrated circuit, which may be configured to perform one or more functionalities of a processor accelerator, e.g., as described below.

In some demonstrative aspects, integrated circuit 110 may include a sensor integrated circuit, which may be configured to perform one or more functionalities of a sensor, e.g., as described below.

In some demonstrative aspects, integrated circuit 110 may include any other additional or alterative type of integrated circuit, which may be configured to perform any other additional or alternative functionality.

In some demonstrative aspects, apparatus 100 may include, or may be implemented as part of, a wireless communication apparatus, which may be configured to perform operations and/or functionalities, which may be subject to, and/or characterized by, changes in current consumption, for example, for processing one or more wireless communications.

In one example, a start of a packet transmission (Tx) may include an instant current demand event, e.g., an instant current increase (jump), for the wireless communication apparatus, e.g., as described below.

In another example, an end of the packet Tx may include an instant current demand event, e.g., an instant current decrease (drop), for the wireless communication apparatus, e.g., as described below.

In another example, a start of a packet reception (Rx) processing may include an instant current demand event, e.g., an instant current increase (jump), for the wireless communication apparatus, e.g., as described below.

In another example, an end of the packet reception (Rx) processing may include an instant current demand event, e.g., an instant current decrease (drop), for the wireless communication apparatus, e.g., as described below.

In another example, a start of an accelerator functionality may include an instant current demand event, e.g., an instant current increase (jump), for the wireless communication apparatus, e.g., as described below.

In another example, an end of an accelerator functionality may include an instant current demand event, e.g., an instant current decrease (drop), for the wireless communication apparatus, e.g., as described below.

In some demonstrative aspects, apparatus 100 may include, or may be implemented as part of, any other computing apparatus or processing apparatus, which may be configured to perform operations and/or functionalities, which may be subject to, and/or characterized by, changes in current consumption, for example, for processing one or more operations, e.g., as described below.

In some demonstrative aspects, one or more ICs 110 of apparatus 100, for example, VLSI circuits and/or any other integrated circuits, e.g., including digital circuits 110, may be configured to employ aggressive power saving techniques and/or perform real time operations, processes and/or algorithms, which may be characterized by current consumption changes.

In some demonstrative aspects, one or more ICs 110 may be configured to employ aggressive power saving techniques and/or perform real time operations, processes and/or algorithms, which may be characterized by instant current consumption changes, which may not be sufficiently supported by and/or handled by a power distribution network (PDN) and/or an external power supply.

In some demonstrative aspects, for example, in some use cases and/or implementations there may be a need to provide a technical solution to supply a current consumption demand of an IC, for example, even during current consumption changes, e.g., instant current consumption changes.

For example, an inability to supply the current consumption demand of the IC, e.g., during fast current consumption transients, may result in instant excessive voltage droops, which may be followed, for example, by circuit malfunction.

For example, in some use cases and/or implementations, relatively large local decupling capacitors may be placed on-die, e.g., near the load source, for example, in order to address the changes in current consumption of the IC. However, the implementation of the large local decupling capacitors may be inefficient, e.g., in terms of area, complexity and/or cost.

For example, in some use cases and/or implementations, a relatively large power supply output capacitor may be implemented, e.g., relatively close to the IC, for example, in order to address the changes in current consumption of the IC. However, the implementation of the relatively large power supply output capacitor may be inefficient, e.g., in terms of area, complexity and/or cost.

For example, in some use cases and/or implementations, a power supply converter with a relatively fast response and/or relatively high accuracy may be utilized, for example, in order to address the changes in current consumption of the IC. However, implementation of the power supply converter with the fast response may be relatively expensive, and/or may be limited by the PDN.

For example, in some use cases and/or implementations, power distribution network constraints, e.g., power planes, bump arrangements, packages, or the like, may be implemented, for example, in order to address the changes in current consumption of the IC. However, the implementation of the power distribution network constraints may be inefficient, e.g., in terms of area, complexity and/or cost.

For example, in some use cases and/or implementations, a modified algorithm and/or mode of IC operation may be implemented, for example, in order to address the technical issues of the instant changes in current consumption. However, this implementation may result in excess target power consumption.

In some demonstrative aspects, apparatus 100 may include a current consumption adjuster 130, which may be configured to adjust and/or control a current consumption from the power supply 170 of an IC 110, e.g., as described below.

In some demonstrative aspects, current consumption adjuster 130 may be configured to adjust and/or control the current consumption from the power supply 170, for example, based on an operation and/or functionality of the integrated circuit 110, e.g., as described below.

In some demonstrative aspects, current consumption adjuster 130 may include controllable load circuitry (“load”) 136, which may be configured to controllably apply one or more loads to the power supply 170, for example, in parallel to the integrated circuit 110, e.g., as described below.

In some demonstrative aspects, current consumption adjuster 130 may include a controller (“load controller”) 132, which may be configured to control activation of the controllable load circuitry 136, e.g., as described below.

In some demonstrative aspects, controller 132 may be configured to control activation of the controllable load circuitry 136, for example, using one or more load control signals 134, e.g., as described below.

In some demonstrative aspects, controller 132 may be configured to identify a current consumption event corresponding to the integrated circuit 110, e.g., as described below.

In some demonstrative aspects, controller 132 may be configured to identify a current consumption event including, for example, a transition of a current consumption of the integrated circuit 110 from the power supply 170, e.g., as described below.

In some demonstrative aspects, controller 132 may be configured to control activation of the controllable load circuitry 136, for example, to apply an event-based load to the power supply 170, for example, based on the current consumption event, e.g., as described below.

In some demonstrative aspects, current consumption adjuster 130 may be implemented together with integrated circuit 110 on a same chip, e.g., as described below.

In some demonstrative aspects, apparatus 100 may include a chip 199 including the integrated circuit 110 and the current consumption adjuster 130, e.g., as described below.

In some demonstrative aspects, current consumption adjuster 130 may be implemented together with power supply 170 on a same chip, e.g., as described below.

In some demonstrative aspects, apparatus 100 may include a chip 198 including the power supply 170 and the current consumption adjuster 130.

In some demonstrative aspects, current consumption adjuster 130 may be implemented together with integrated circuit 110 and power supply 170 on a same chip, e.g., as described below.

In some demonstrative aspects, apparatus 100 may include a chip including the integrated circuit 110, the power supply 170, and the current consumption adjuster 130.

In some demonstrative aspects, controller 132 may be configured to identify the current consumption event of integrated circuit 110, for example, based on an event indication 120 from the integrated circuit 110, e.g., as described below.

In other aspects, controller 132 may be configured to identify the current consumption event of integrated circuit 110 based on any other additional or alternative indication, e.g., from any other element of apparatus 100.

In some demonstrative aspects, controllable load circuitry 136 may be configured to apply the event-based load to the power supply 170 within a relatively short time period, e.g., as described below.

In some demonstrative aspects, controllable load circuitry 136 may be configured to apply the event-based load to the power supply 170 within a response time of less than 100 nanoseconds, e.g., as described below.

In some demonstrative aspects, controllable load circuitry 136 may be configured to apply the event-based load to the power supply 170 within a response time of 50 nanoseconds or less, e.g., as described below.

In other aspects, controllable load circuitry 136 may be configured to apply the event-based load to the power supply 170 according to any other suitable response time.

In some demonstrative aspects, controller 132 may be configured to configure the event-based load to be applied by the controllable load circuitry 136, for example, based on the current consumption event, e.g., as described below.

In some demonstrative aspects, controller 132 may be configured to determine a timing of the event-based load to be applied by the controllable load circuitry 136, for example, based on the current consumption event, e.g., as described below.

In some demonstrative aspects, controller 132 may be configured to determine a load magnitude of the event-based load to be applied by the controllable load circuitry 136, for example, based on the current consumption event, e.g., as described below.

In some demonstrative aspects, controller 132 may be configured to determine a load duration of the event-based load to be applied by the controllable load circuitry 136, for example, based on the current consumption event, e.g., as described below.

In some demonstrative aspects, controller 132 may be configured to determine a slew rate of the event-based load to be applied by the controllable load circuitry 136, for example, based on the current consumption event, e.g., as described below.

In some demonstrative aspects, controller 132 may be configured to determine a start time of the event-based load to be applied by the controllable load circuitry 136, for example, based on the current consumption event, e.g., as described below.

In some demonstrative aspects, controller 132 may be configured to determine an end time of the event-based load to be applied by the controllable load circuitry 136, for example, based on the current consumption event, e.g., as described below.

In some demonstrative aspects, controller 132 may be configured to determine any other additional or alternative parameter and/or configuration of the event-based load to be applied by the controllable load circuitry 136.

In some demonstrative aspects, controller 132 may be configured to determine a load period based on the current consumption event, and to control the controllable load circuitry 136 to apply the event-based load during the load period, e.g., as described below.

In some demonstrative aspects, controller 132 may be configured to determine the load period to begin, for example, prior to the transition of the current consumption of the integrated circuit 110, e.g., as described below.

In some demonstrative aspects, controller 132 may be configured to determine the load period to begin, for example, prior to the transition of the current consumption of the integrated circuit, for example, based on a determination that the transition of the current consumption of the integrated circuit 110 includes an increase of the current consumption of the integrated circuit 110, e.g., as described below.

In some demonstrative aspects, controller 132 may be configured to determine the load period to begin at or after the transition of the current consumption of the integrated circuit 110, e.g., as described below.

In some demonstrative aspects, controller 132 may be configured to determine the load period to begin at or after the transition of the current consumption of the integrated circuit 110, for example, based on a determination that the transition of the current consumption of the integrated circuit 110 include a decrease of the current consumption of the integrated circuit 110, e.g., as described below.

In other aspects, controller 132 may be configured to determine the load period any other timing of the load period based on any other additional or alternative criteria and/or condition.

In some demonstrative aspects, controller 132 may be configured to control the controllable load circuitry 136 to apply the event-based load including a monotonically changing load magnitude during the load period, e.g., as described below.

In some demonstrative aspects, controller 132 may be configured to control the controllable load circuitry 136 to apply the event-based load including a monotonically increasing load magnitude during the load period, e.g., as described below.

In some demonstrative aspects, controller 132 may be configured to control the controllable load circuitry 136 to apply the event-based load including a monotonically increasing load magnitude during the load period, for example, based on a determination that the transition of the current consumption of the integrated circuit 110 includes an increase of the current consumption of the integrated circuit, e.g., as described below.

In some demonstrative aspects, controller 132 may be configured to control the controllable load circuitry 136 to apply the event-based load including a monotonically decreasing load magnitude during the load period, e.g., as described below.

In some demonstrative aspects, controller 132 may be configured to control the controllable load circuitry 136 to apply the event-based load including a monotonically decreasing load magnitude during the load period, for example, based on a determination that the transition of the current consumption of the integrated circuit 110 includes a decrease of the current consumption of the integrated circuit, e.g., as described below.

In other aspects, controller 132 may be configured to control the controllable load circuitry 136 to apply the event-based load according to any other load configuration based on any other additional or alternative criteria and/or condition.

In some demonstrative aspects, controller 132 may be configured to control the controllable load circuitry 136 to apply the event-based load, which may be configured, for example, to result in an adjusted transition of the current consumption from the power supply 170, e.g., as described below.

In some demonstrative aspects, the adjusted transition of the current consumption from the power supply 170 may be configured, for example, based on a combination of the transition of the current consumption of the integrated circuit 110 and a load-based current consumption of the event-based load applied by the controllable load circuitry 136, e.g., as described below.

In some demonstrative aspects, controller 132 may be configured to control the controllable load circuitry 136 to apply the event-based load, for example, based on a determination that the transition of the current consumption of the integrated circuit 110 includes a first transition from a first current to a second current within a first transition period, e.g., as described below.

In some demonstrative aspects, controller 132 may be configured to control the controllable load circuitry 136 to apply the event-based load, for example, such that the adjusted transition of the current consumption from the power supply 170 may include a second transition from the first current to the second current, for example, within a second transition period, e.g., as described below.

In some demonstrative aspects, an absolute difference between the first current and the second current may be at least 0.2 Ampere (A).

In some demonstrative aspects, an absolute difference between the first current and the second current may be at least 0.3 A.

In some demonstrative aspects, an absolute difference between the first current and the second current may be at least 0.5 A.

In some demonstrative aspects, an absolute difference between the first current and the second current may be at least 1 A.

In some demonstrative aspects, an absolute difference between the first current and the second current may be at least 1.5 A.

In other aspects, the transition between the first current and the second current may have any other suitable magnitude.

In some demonstrative aspects, controller 132 may be configured to control the controllable load circuitry 136 to apply the event-based load, for example, such that the second transition period may be longer than the first transition period, e.g., as described below.

In some demonstrative aspects, controller 132 may be configured to control the controllable load circuitry 136 to apply the event-based load, for example, such that the second transition period may be at least 5 times longer than the first transition period, e.g., as described below.

In some demonstrative aspects, controller 132 may be configured to control the controllable load circuitry 136 to apply the event-based load, for example, such that the second transition period may be at least 10 times longer than the first transition period, e.g., as described below.

In some demonstrative aspects, controller 132 may be configured to control the controllable load circuitry 136 to apply the event-based load, for example, such that the second transition period may be at least 20 times longer than the first transition period, e.g., as described below.

In some demonstrative aspects, the first transition period may be, for example, less than 500 nanoseconds, e.g., as described below.

In some demonstrative aspects, the second transition period may be longer than 1 microsecond, e.g., as described below.

In other aspects, the first transition period and/or the second transition period may have any other suitable duration.

In some demonstrative aspects, as shown in FIG. 1, current consumption adjuster 130 may be configured to adjust the current consumption from the power supply 170, for example, based on current consumption events corresponding to a plurality of integrated circuits 110, which may be connected, e.g., in parallel, to the power supply 170, e.g., as described below.

In some demonstrative aspects, controller 132 may be configured to identify a plurality of at least partially-overlapping current consumption events corresponding to the plurality of integrated circuits 110, e.g., as described below.

In some demonstrative aspects, the plurality of at least partially-overlapping current consumption events may include, for example, a first current consumption event corresponding to a first integrated circuit 110 and a second current consumption event corresponding to a second integrated circuit 110.

In some demonstrative aspects, the second current consumption event may at least partially overlap in time with the first current consumption event.

In some demonstrative aspects, controller 132 may be configured to control activation of the controllable load circuitry 136, for example, to apply the event-based load to power supply 170, for example, based on the plurality of at least partially-overlapping current consumption events, e.g., as described below.

For example, controller 132 may determine that the first current consumption event corresponding to a first integrated circuit 110 includes a current consumption decrease, and that the second current consumption event corresponding to a first integrated circuit 110 includes a current consumption increase.

For example, controller 132 may be configured to control activation of the controllable load circuitry 136, for example, to apply the event-based load to power supply 170, for example, based on a combination of the first current consumption event and the second current consumption event.

In one example, controller 132 may be configured to control activation of the controllable load circuitry 136, for example, to apply the event-based load to power supply 170, for example, based on a difference between absolute magnitudes of the current consumption increase and the current consumption decrease.

In some demonstrative aspects, the controllable load circuitry 136 may include a load array 138, e.g., as described below.

In some demonstrative aspects, controllable load circuitry 136 may include a plurality of load banks, e.g., parallel load banks, which may be configured to provide a respective plurality of loads, e.g., as described below.

In some demonstrative aspects, controller 132 may be configured to selectively activate one or more load banks of the plurality of load banks, e.g., parallel load banks, of controllable load circuitry 136, e.g., as described below.

In some demonstrative aspects, controller 132 nay be configured to selectively activate one or more load banks of the plurality of load banks, e.g., parallel load banks, of controllable load circuitry 136, for example, according to the event-based load to be applied to the power supply 170 based on the current consumption event, e.g., as described below.

In some demonstrative aspects, the plurality of load banks, e.g., parallel load banks, may include at least two different load banks, which may be configured to provide at least two respective different loads, e.g., as described below.

In some demonstrative aspects, the plurality of load banks, e.g., parallel load banks, may include at least two equal load banks, which may be configured to provide a same load, e.g., as described below.

In some demonstrative aspects, a load bank of controllable load circuitry 136 may be configured to include one or more bank cells, e.g., as described below.

In some demonstrative aspects, a bank cell may be configured to include a plurality of load cells, e.g., as described below.

In other aspects, controllable load circuitry 136 may be configured according to any other suitable architecture.

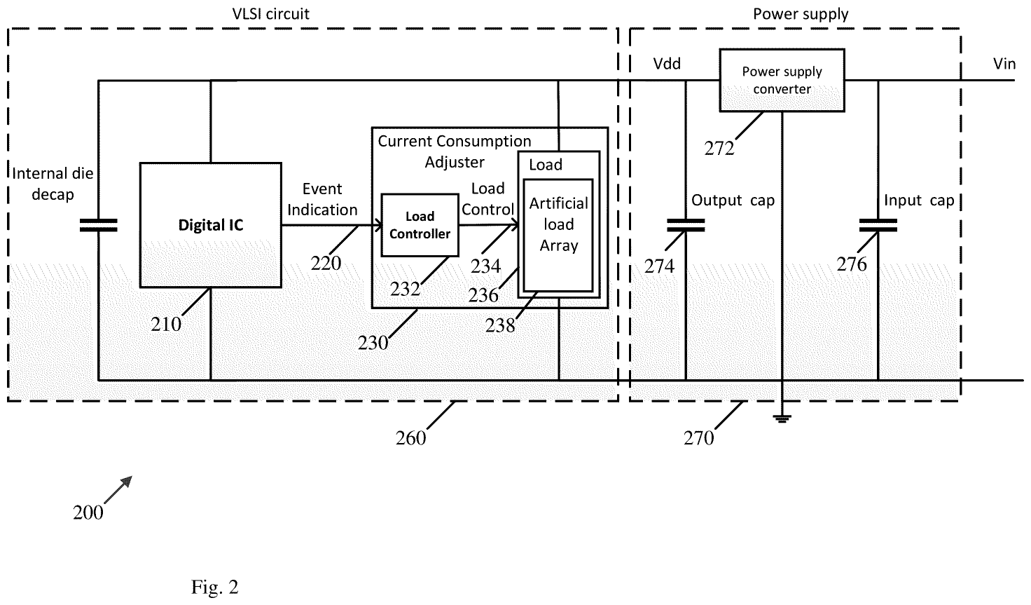

Reference is made to FIG. 2, which schematically illustrates an apparatus 200, in accordance with some demonstrative aspects. For example, apparatus 100 (FIG. 1) may include one or more elements of apparatus 200, and/or apparatus 100 (FIG. 1) may be configured to perform one or more operations and/or functionalities of apparatus 200.

In some demonstrative aspects, as shown in FIG. 2, apparatus 200 may include one or more integrated circuits (ICs) 210, e.g., digital ICs 210.

In some demonstrative aspects, the one or more integrated circuits 210 may include one or more digital ICs and/or any other ICs, e.g., as described below.

In some demonstrative aspects, apparatus 200 may include one or more VLSI ICs 260, for example, including the one or more ICs 210, e.g., as described below.

In some demonstrative aspects, as shown in FIG. 2, apparatus 200 may include, or may be associated with, at least one power supply 270 to provide power to the integrated circuits 210, e.g., as described below.

In some demonstrative aspects, as shown in FIG. 2, the power supply 270 may include, for example, a power supply converter 272, e.g., a switching converter or a linear converter, for example, with an output capacitor 247 and an input capacitor 276.

In some demonstrative aspects, the digital ICs 210 may include, for example, any suitable digital IP IC, a processor IC, an accelerator IC, and/or any other type of IC.

In some demonstrative aspects, apparatus 200 may include a current consumption adjuster 230, which may be configured to adjust and/or control a current consumption from the power supply 270 of an IC 210, e.g., as described below. For example, current consumption adjuster 130 (FIG. 1) may include one or more elements of current consumption adjuster 230, and/or current consumption adjuster 130 (FIG. 1) may be configured to perform one or more operations and/or functionalities of current consumption adjuster 230.

In some demonstrative aspects, current consumption adjuster 230 may be configured to adjust and/or control the current consumption from the power supply 270, for example, based on an operation and/or functionality of the integrated circuit 210, e.g., as described below.

In some demonstrative aspects, as shown in FIG. 2, apparatus 200 may include a load (also referred to as “artificial load”) 236, which may be controllably applied to a power supply of the IC 210, e.g., as described below.

In some demonstrative aspects, as shown in FIG. 2, the artificial load 236 may be connected to the power supply 270, for example, in parallel to the IC 210.

In some demonstrative aspects, the artificial load 236 may be implemented in the form of an artificial load array circuit 238, e.g., as described below.

In other aspects, the artificial load 236 may be implemented by any other load circuitry and/or according to any other load architecture.

In some demonstrative aspects, the load 236 may be controllably and/or selectively applied to control a current consumption from power supply 270, for example, based on operation of the IC 210, e.g., as described below.

In some demonstrative aspects, the load 236 may be controlled to smoothen the current consumption from power supply 270, for example, based on operation of the IC 210, e.g., as described below.

In some demonstrative aspects, the load 236 may be configured to selectively and/or controllably apply a plurality of different load levels to the power supply 270 of the IC 210, e.g., as described below.

In some demonstrative aspects, the load 236 may include a plurality of load banks, which may be selectively and/or controllably activated, for example, to apply the plurality of load levels to the power supply 270 of the IC 210, e.g., as described below.

In some demonstrative aspects, as shown in FIG. 2, apparatus 200 may include a controller (also referred to as “load controller”) 232, which may be configured to control the load to be applied by artificial load 236 to the power supply 270 of the IC 210, for example, based on an operational state of the IC 210, and/or based on an operation and/or process to be performed by the IC 210, e.g., as described below.

In some demonstrative aspects, the load controller 232 may be configured to control a load level of the load to be applied by artificial load 236 to the power supply 270 of the IC 210, for example, based on an operational state of the IC 210, and/or based on an operation and/or process to be performed by the IC 210, e.g., as described below.

In some demonstrative aspects, the load controller 232 may be configured to control a load level of the load to be applied by artificial load 236 to the power supply 270 of the IC 210, for example, by selectively activating or de-activating load banks of the artificial load 236, e.g., as described below.

For example, the load controller 232 may be configured to activate a first set of one or more load banks of the artificial load 236, for example, to apply a first load level to the power supply 270 of the IC 210.

For example, the load controller 232 may be configured to activate a second set of one or more load banks of the artificial load 236, for example, to apply a second load level, e.g., different from the first load level, to the power supply 270 of the IC 210.

In some demonstrative aspects, the load controller 232 may be configured to control a timing at which the load is to be applied by artificial load 236 to the power supply 270 of the IC 210, for example, based on an operational state of the IC 210, and/or based on an operation and/or process to be performed by the IC 210, e.g., as described below.

In some demonstrative aspects, the load controller 232 may be configured to control a time duration during which the load is to be applied by artificial load 236 to the power supply 270 of the IC 210, for example, based on an operational state of the IC 210, and/or based on an operation and/or process to be performed by the IC 210, e.g., as described below.

In some demonstrative aspects, the load controller 232 may be configured to control a start time at which the load is to be applied by artificial load 236 to the power supply 270 of the IC 210, for example, based on an operational state of the IC 210, and/or based on an operation and/or process to be performed by the IC 210, e.g., as described below.

In some demonstrative aspects, the load controller 232 may be configured to control an end time at which the load of artificial load 236 is to be removed from the power supply 270 of the IC 210, for example, based on an operational state of the IC 210, and/or based on an operation and/or process to be performed by the IC 210, e.g., as described below.

In some demonstrative aspects, the controller 232 may be configured to constrain in time, e.g., to strictly constrain in time, the load to be applied by artificial load 236 to the power supply 270 of the IC 210, for example, to smooth one or more current consumption steps, e.g., as described below.

In some demonstrative aspects, the controller 232 may be configured to control the load to be applied by artificial load 236 to the power supply 270 of the IC 210, for example, in a way that current consumption steps, e.g., resulting from the load, may be supported, e.g., well supported, by a PDN, e.g., a conventional PDN, and/or the power supply 270.

In some demonstrative aspects, load controller 232 may be configured to selectively enable or disable the artificial load to be applied by artificial load 236 to the power supply 270 of the IC 210, for example, substantially immediately, for example, as a response to predictor trigger signals 220 from the digital logic circuit 210.

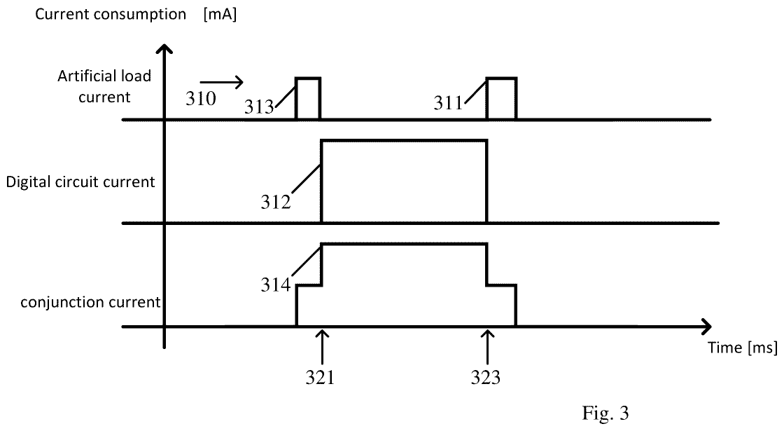

In some demonstrative aspects, controller 232 may be configured to selectively control the artificial load to be applied by artificial load 236 to the power supply 270 of the IC 210, for example, such that a conjunction of an artificial load current consumption, which may result, for example, from the artificial load, and a natural digital logic circuit current consumption of the IC 210, may result in a relatively limited current step, which may be sufficient to allow a gradual PDN response on this current step, for example, as described below with reference to FIG. 3.

In some demonstrative aspects, as shown in FIG. 2, the digital integrated circuit 210 may be configured to generate one or more event indications 220, for example, to indicate one or more predefined events, which may be associated with current demand changes, e.g., instant current demand changes, of the integrated circuit 210.

In some demonstrative aspects, as shown in FIG. 2, controller 232 may be configured to receive the event indications 220 from the IC 210, for example, via an event-indications bus, and/or via any other suitable communication interface.

In some demonstrative aspects, as shown in FIG. 2, an artificial load mechanism, e.g., the current consumption adjuster 230, including the load controller 232 and the artificial load array circuit 236, may be fully integrated within the VLSI circuit 260, for example, on the same SOC/die as the digital integrated circuit 210.

In other aspects, one or more components of the artificial load mechanism, e.g., the load controller 232 and/or the artificial load 236, may be implemented as separate and/or independent elements, e.g., external to and/or separate from, the SOC/die including the digital integrated circuit 210.

In some demonstrative aspects, controller 232 may be configured to generate control signals 234 to control a start time and/or end time of an activation of the artificial load 236 at various magnitudes, e.g., as described below.

In some demonstrative aspects, controller 232 may be configured to generate the control signals 234 to control the activation/de-activation of the artificial load 236, for example, based on the digital integrated circuit event indications 220, e.g., provided by the integrated circuit 210, and/or any other suitable element of apparatus 200.

In some demonstrative aspects, controller 232 may be configured to generate the control signals 234 to control the activation/de-activation of the artificial load 236, for example, to compensate high current transients in open loop, e.g., even without real time current measurement of the actual current consumption from power supply 270.

In some demonstrative aspects, controller 232 may be configured to tune and/or shape one or more artificial load profile parameters of the artificial load applied by load 236, for example, per event.

In some demonstrative aspects, artificial load profile parameters of the artificial load may include, for example, a gradual start duration, e.g., an “on” slew rate, an active duration, an active magnitude, a gradual end duration, e.g., an “off” slew rate, and/or any other additional or alternative parameter of the artificial load 236.

In one example, the artificial load profile may be configured, for example, in a lab, e.g., during an integration phase.

In some demonstrative aspects, the artificial load 236 may include load circuitry, which may be configured to apply to the power supply 270 a load current, e.g., a controlled load current, for example, with a relatively high resolution and/or a relatively fast response, e.g., as described below.

In some demonstrative aspects, load controller 232 may be configured to control activation of the load circuitry 236, for example, based on real time controls 220, for example, to provide a technical solution to achieve synchronization, e.g., substantially perfect and/or tight synchronization, between the load applied to the power supply 270 by the artificial load 236 and the natural load of the digital ICs 210.

In some demonstrative aspects, load controller 232 may be configured to control activation of the load circuitry 236, for example, to provide a technical solution to smoothen a current consumption change, which would result from the natural load of the digital ICs 210, e.g., as described below.

Reference is made to FIG. 3, which illustrates a graph depicting an artificial load current 310 configured based on a current consumption 312 of circuitry, in accordance with some demonstrative aspects.

For example, a load controller, e.g., load controller 132 (FIG. 1) and/or load controller 232 (FIG. 2), may be configured to control activation of load circuitry, e.g., load circuitry 136 (FIG. 1) and/or load circuitry 236 (FIG. 2), to apply to a power supply, e.g., the power supply 170 (FIG. 1) and/or the power supply 270 (FIG. 2), an artificial load, which may result in the artificial load current 310.

For example, the load controller, e.g., load controller 132 (FIG. 1) and/or load controller 232 (FIG. 2), may be configured to control activation of the load circuitry, e.g., load circuitry 136 (FIG. 1) and/or load circuitry 236 (FIG. 2), to apply the artificial load resulting in the artificial load current 310, for example, based on the current consumption 312, which may be applied by an integrated circuit, e.g., integrated circuitry 110 (FIG. 1) and/or integrated circuitry 210 (FIG. 2).

In some demonstrative aspects, as shown in FIG. 3, the load controller, e.g., load controller 132 (FIG. 1) and/or load controller 232 (FIG. 2), may be configured trigger, cause and/or control the artificial load, e.g., load circuitry 136 (FIG. 1) and/or load circuitry 236 (FIG. 2), to apply a predefined load level 310 to the power supply of the IC, e.g., the power supply 170 (FIG. 1) of IC 110 (FIG. 1) and/or the power supply 270 (FIG. 2) of IC 210 (FIG. 2), for example, based on an expected transition, e.g., a relatively sharp transition, in the current consumption 312 of the IC.

In some demonstrative aspects, as shown in FIG. 3, the load controller, e.g., load controller 132 (FIG. 1) and/or load controller 232 (FIG. 2), may be configured to trigger, cause and/or control the artificial load, e.g., load circuitry 136 (FIG. 1) and/or load circuitry 236 (FIG. 2), to apply to the power supply of the IC, e.g., the power supply 170 (FIG. 1) of IC 110 (FIG. 1) and/or the power supply 270 (FIG. 2) of IC 210 (FIG. 2), a predefined load level 310, which may be configured, for example, to provide a smoother transition in a conjunction current 314, which may be based on conjunction of the artificial load current consumption 310, e.g., resulting from the artificial load, and the natural digital logic circuit current consumption 312 of the IC.

In some demonstrative aspects, as shown in FIG. 3, the load controller, e.g., load controller 132 (FIG. 1) and/or load controller 232 (FIG. 2), may be configured to trigger, cause and/or control the artificial load, e.g., load circuitry 136 (FIG. 1) and/or load circuitry 236 (FIG. 2), to apply a predefined load level 311 to the power supply of the IC, e.g., the power supply 170 (FIG. 1) of IC 110 (FIG. 1) and/or the power supply 270 (FIG. 2) of IC 210 (FIG. 2), for example, at least before, e.g., right before, a time 321 of an expected increase, e.g., a relatively sharp increase, in the current consumption 312 of the IC.

In some demonstrative aspects, as shown in FIG. 3, the load controller, e.g., load controller 132 (FIG. 1) and/or load controller 232 (FIG. 2), may be configured to trigger, cause and/or control the artificial load, e.g., load circuitry 136 (FIG. 1) and/or load circuitry 236 (FIG. 2), to apply a predefined load level 313 to the power supply of the IC, e.g., the power supply 170 (FIG. 1) of IC 110 (FIG. 1) and/or the power supply 270 (FIG. 2) of IC 210 (FIG. 2), for example, at least after, e.g., right after, a time 323 of an expected decrease, e.g., a relatively sharp decrease, in the current consumption 312 of the IC.

Referring back to FIG. 2, in some demonstrative aspects, artificial load circuitry 236 may include, and/or may be implemented via, a plurality of library cells, for example, an array of library cells 238, e.g., as described below.

In some demonstrative aspects, the array of library cells 238 may include an array of customized standard library cells, e.g., as described below.

In other aspects, the artificial load circuitry 236 may include any other suitable additional or alternative type and/or architecture of load circuitry, which may be selectively and/or controllably activated.

In some demonstrative aspects, the library cells of the artificial load circuitry 236 may be divided into a plurality of load banks, e.g., 16 banks or any other suitable number of banks, e.g., as described below.

In some demonstrative aspects, a load bank, e.g., each load bank, of the load array 238 may be configured to include a relatively large number of load cells, for example, a few hundred small load cells or any other number of load cells, e.g., as described below.

In some demonstrative aspects, the load cells of a bank of the load array 238 may be connected, for example, in a daisy chain fashion, and placed within the physical partition.

In some demonstrative aspects, the plurality of banks may be configured to include two or more different banks.

In one example, all banks of the plurality of banks may be different from one another, e.g., to apply different loads.

In another example, the plurality of banks may include two or more similar, e.g., identical, banks, e.g., to apply a same load magnitude.

In some demonstrative aspects, the plurality of banks of the load array 238 may be operated by controller 232, e.g., activated or deactivated, separately and/or independently, for example, to provide a technical solution to support a fine granularity of load magnitudes, e.g., as described below.

In some demonstrative aspects, the plurality of banks of the load array 238 may be operated by controller 232, e.g., activated or deactivated, separately and/or independently, for example, to provide a technical solution to generate the artificial current consumption relatively fast, e.g., faster than the natural current consumed by the integrated circuit 210.

In some demonstrative aspects, the plurality of banks of the load array 238 may be implemented according to a distributed implementation, which may be configured to provide a technical solution to generate a relatively large magnitude of artificial current consumption, e.g., up to about 1 A of artificial current or even more, for example, within a relatively very short time period, e.g., within about 50 nano-seconds (ns) or any other suitable response time, e.g., as described below.

In some demonstrative aspects, the plurality of banks of the load array 238 may be configured to provide the relatively large magnitude of artificial current consumption with a relatively short response time, which may be, for example, about 2-3 times faster than the transition time of the natural (real) load current of the digital IC 210.

In other aspects, the plurality of banks of the load array 238 may be configured to support any other artificial current consumption level and/or at any other response time.

In some demonstrative aspects, the distributed implementation of the plurality of banks of the load array 238 may be configured to provide a technical solution to generate the relatively large artificial current consumption within the very short time period, for example, with very minor impact on the actual digital circuitry 210.

For example, the distributed implementation of the plurality of banks of the load array 238 may be configured to provide a technical solution to create an effect of local decoupling capacitance, for example, with a much lower silicon area footprint, e.g., compared to a standard decoupling capacitor cells solution.

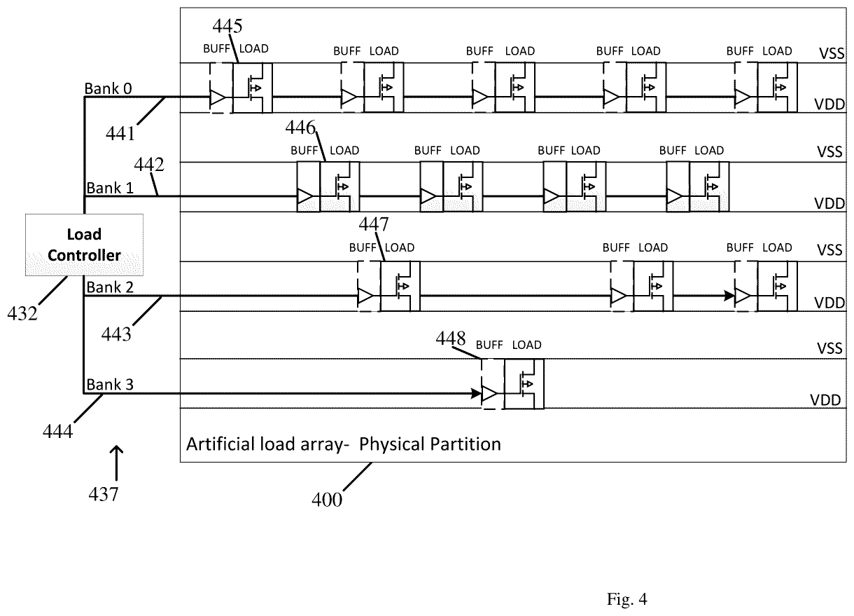

Reference is made to FIG. 4, which schematically illustrates load circuitry 400, in accordance with some demonstrative aspects.

For example, controllable load circuitry 136 (FIG. 1) and/or controllable load circuitry 236 (FIG. 2) may be configured to implement one or more elements and/or functionalities of the load circuitry 400.

In some demonstrative aspects, as shown in FIG. 4, load circuitry 400 may include load array circuitry, which may be controlled by a load controller 432.

For example, controller 132 (FIG. 1) and/or controller 232 (FIG. 2) may be configured to implement one or more elements and/or functionalities of the load controller 432.

In some demonstrative aspects, as shown in FIG. 4, the load circuitry array may include a plurality of banks 437, which may be configured to provide a plurality of respective loads.

In some demonstrative aspects, as shown in FIG. 4, the plurality of banks 437 may include four banks, which may be configured to provide four respective loads.

In other aspects, the plurality of banks 437 may include any other number of banks, which may be configured to provide any other number of respective loads.

In some demonstrative aspects, as shown in FIG. 4, the four banks 437 may be configured to provide four different load sizes.

In other aspects, two or more banks 437 may be configured to provide a substantially same load size.

In some demonstrative aspects, as shown in FIG. 4, a bank 437 may include one or more cells.

In some demonstrative aspects, as shown in FIG. 4, a first bank 441 may include 5 cells 445.

In some demonstrative aspects, as shown in FIG. 4, a second bank 442 may include 4 cells 446.

In some demonstrative aspects, as shown in FIG. 4, a third bank 443 may include 3 cells 447.

In some demonstrative aspects, as shown in FIG. 4, a fourth bank 444 may include 1 cell 448.

In some demonstrative aspects, as shown in FIG. 4, the load circuitry 400 may include a total of 13 cells.

In other aspects, any other count of cells and/or any other distribution of the cells between the banks may be implemented.

In some demonstrative aspects, a cell, e.g., each cell, of the cells 445, 446, 447, and/or 448, may include a plurality of load cells, for example, N cells, e.g. N=200 or any other suitable value.

In some demonstrative aspects, the plurality of banks 437 may be controllably activated or deactivated by the load controller 432.

In some demonstrative aspects, controller 432 may be configured to selectively activate the banks 437, for example, such that accumulation of all activated banks over time may shape the load pattern applied by the load circuitry 400.

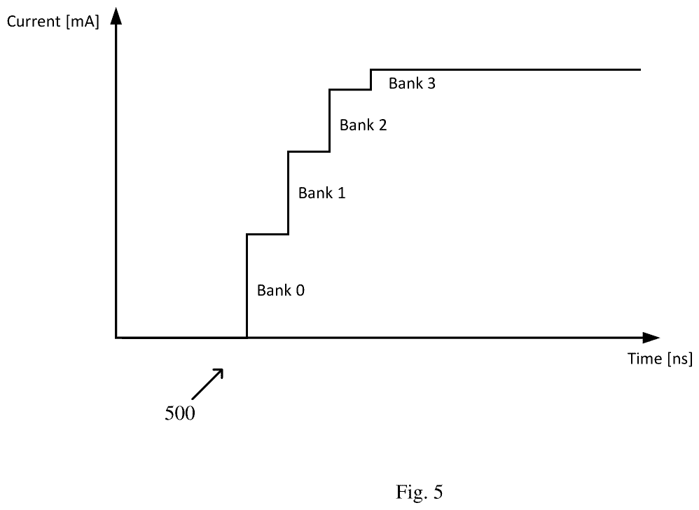

Reference is made to FIG. 5, which schematically illustrates a load current pattern of load circuitry, in accordance with some demonstrative aspects.

For example, controller 432 (FIG. 4) may be configured to selectively activate the banks 437 (FIG. 4), for example, according to the load current pattern 500.

In one example, a load cell, e.g., each cell, of the cells 445, 446, 447, and/or 448 (FIG. 4), may be configured to apply a load size of about 350 nano Ampere (nA). According to this example, controller 432 (FIG. 4) may be configured to selectively activate the banks 437 (FIG. 4), for example, according to the load current pattern 500, for example, to support a load of up to about 910 mA, e.g., 200×350 nA=˜=70 mA×13=˜ 910 mA.

Referring back to FIG. 1, in some demonstrative aspects, digital IC 110 may include a wireless communication IC, which may be configured, for example, to perform one or more operations and/or functionalities of processing one or more wireless communications.

In some demonstrative aspects, current consumption adjuster 130 may be configured to apply to power supply 170 a load, which may be configured based on a current consumption transition at a wireless communication operation of the integrated circuit 110, e.g., as described below.

In some demonstrative aspects, current consumption adjuster 130 may be configured to apply to power supply 170 a load, which may be configured based on a current consumption transition at a start of a packet Tx operation, e.g., as described below.

In some demonstrative aspects, current consumption adjuster 130 may be configured to apply to power supply 170 a load, which may be configured based on a current consumption transition at an end of the packet Tx operation, e.g., as described below.

In some demonstrative aspects, current consumption adjuster 130 may be configured to apply to power supply 170 a load, which may be configured based on a current consumption transition at a start of a packet Rx operation, e.g., as described below.

In some demonstrative aspects, current consumption adjuster 130 may be configured to apply to power supply 170 a load, which may be configured based on a current consumption transition at an end of the packet Rx operation, e.g., as described below.

In other aspects, current consumption adjuster 130 may be configured to apply to power supply 170 a load, which may be configured based on a current consumption transition corresponding to any other additional or alternative wireless communication operation and/or functionality of the wireless communication IC 110.

Some demonstrative aspects are described above with respect to a current consumption adjuster, e.g., current consumption adjuster 130, which may be configured to adjust the current consumption from a power supply, e.g., power supply 170, based on wireless communication operations and/or functionalities of an integrated circuit, e.g., integrated circuit 110, as described above.

In other aspects, the current consumption adjuster, e.g., current consumption adjuster 130, may be configured to adjust the current consumption from the power supply, e.g., power supply 170, based on any other additional or alternative operations and/or functionalities of any other type of integrated circuit, e.g., integrated circuit 110.

In some demonstrative aspects, the current consumption adjuster, e.g., current consumption adjuster 130, may be implemented, for example, for ICs having relatively high current consumption steps, which are predictable and/or periodic.

In some demonstrative aspects, the current consumption adjuster, e.g., current consumption adjuster 130, may be implemented, for example, for an image sensor integrated circuit, e.g., integrated circuit 110, for example, to adjust current consumption transitions at a start/end of an image capturing operation.

In one example, the current consumption adjuster, e.g., current consumption adjuster 130, may be configured to trigger an artificial load, for example, per frame, e.g., before an exposure start, after pixel array readout and/or when post processing ends.

In some demonstrative aspects, the current consumption adjuster, e.g., current consumption adjuster 130, may be implemented, for example, for a processor integrated circuit, e.g., integrated circuit 110.

In one example, the current consumption adjuster, e.g., current consumption adjuster 130, may be configured to trigger an artificial load, for example, at a start/end of a long pipeline operation, e.g., from/to memory/cache, and/or at start/end of accelerator operations.

In some demonstrative aspects, the current consumption adjuster, e.g., current consumption adjuster 130, may be implemented, for example, for a solid state relay, for example, to reduce an inrush current, for example, by triggering the artificial load and delaying a switch operation.

In some demonstrative aspects, the current consumption adjuster, e.g., current consumption adjuster 130, may be implemented, for example, for a radar/IoT IC sensor, for example, to reduce inrush current, e.g., by triggering artificial load on start/end periodically measurement.

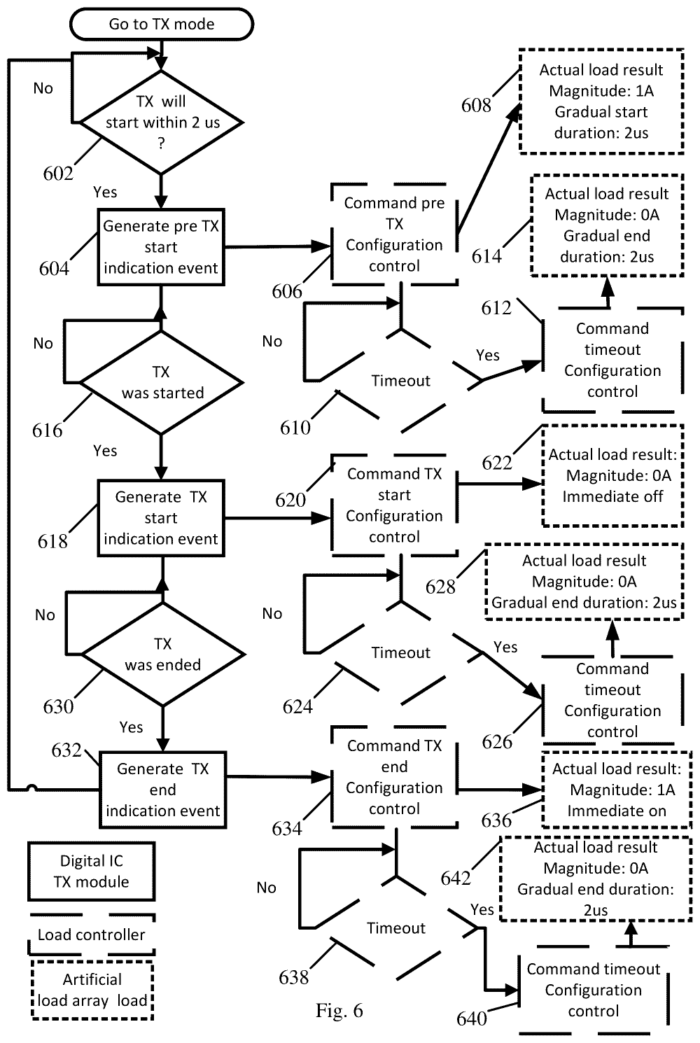

Reference is made to FIG. 6, which illustrates a method of current consumption adjustment, in accordance with some demonstrative aspects. For example, one or more of the operations of the method of FIG. 6 may be performed by a current consumption adjuster, e.g., current consumption adjuster 130 (FIG. 1) and/or current consumption adjuster 230 (FIG. 2), a controller, e.g., controller 132 (FIG. 1) and/or controller 232 (FIG. 2), and/or controllable load circuitry, e.g., controllable load circuitry 136 (FIG. 1) and/or controllable load circuitry 236 (FIG. 2).

In some demonstrative aspects, as indicated at block 602, the method may include identifying a packet Tx operation expected to begin within a predefined time period, e.g., within 2 microseconds (us) or any other time period. For example, integrated circuit 110 (FIG. 1) may identify that the packet Tx operation is expected to begin within the predefined time period.

In some demonstrative aspects, as indicated at block 604, the method may include generating a pre-Tx start event indication, for example, based on a determination that a packet Tx operation is expected to begin within the predefined time period. For example, integrated circuit 110 (FIG. 1) may generate an indication signal 120 (FIG. 1), which may be configured to indicate the pre-Tx start event to controller 132 (FIG. 1), e.g., as described above.

In some demonstrative aspects, as indicated at block 606, the method may include triggering the generation of an artificial load corresponding to the pre-Tx start event. For example, controller 132 (FIG. 1) may generate a control signal 134 (FIG. 1), which may be configured to trigger the controllable load circuitry 136 (FIG. 1) to apply the artificial load corresponding to the pre-Tx start event, e.g., as described above.

In some demonstrative aspects, as indicated at block 608, the method may include applying the artificial load corresponding to the pre-Tx start event. For example, controllable load circuitry 136 (FIG. 1) may gradually apply the artificial load corresponding to the pre-Tx start event, e.g., as described above.

In some demonstrative aspects, as indicated at blocks 610 and 612, the method may include maintaining the artificial load corresponding to the pre-Tx start event for a predefined timeout period, and triggering deactivation of the artificial load corresponding to the pre-Tx start event based on the expiration of the timeout period. For example, controller 132 (FIG. 1) may generate a control signal 134 (FIG. 1), which may be configured to trigger the controllable load circuitry 136 (FIG. 1) to deactivate the artificial load corresponding to the pre-Tx start event based on the expiration of the timeout period, e.g., as described above.

In some demonstrative aspects, as indicated at block 614, the method may include deactivating the artificial load corresponding to the pre-Tx start event. For example, controllable load circuitry 136 (FIG. 1) may gradually deactivate the artificial load corresponding to the pre-Tx start event, e.g., as described above.

In some demonstrative aspects, as indicated at block 616, the method may include identifying a beginning of the packet Tx operation. For example, integrated circuit 110 (FIG. 1) may identify the start of the packet Tx operation.

In some demonstrative aspects, as indicated at block 618, the method may include generating a Tx start event indication, for example, based on a determination of a start of that the packet Tx operation. For example, integrated circuit 110 (FIG. 1) may generate an indication signal 120 (FIG. 1), which may be configured to indicate the Tx start event to controller 132 (FIG. 1), e.g., as described above.

In some demonstrative aspects, as indicated at block 620, the method may include triggering the setting of an artificial load corresponding to the Tx start event. For example, controller 132 (FIG. 1) may generate a control signal 134 (FIG. 1), which may be configured to trigger the controllable load circuitry 136 (FIG. 1) to set the artificial load corresponding to the Tx start event, e.g., as described above.

In some demonstrative aspects, as indicated at block 622, the method may include setting the artificial load corresponding to the Tx start event. For example, controllable load circuitry 136 (FIG. 1) may immediately set the artificial load to zero, e.g., as described above.

In some demonstrative aspects, as indicated at blocks 624 and 626, the method may include maintaining the setting of the artificial load corresponding to the Tx start event for a predefined timeout period, and triggering deactivation of the artificial load setting corresponding to the Tx start event based on the expiration of the timeout period. For example, controller 132 (FIG. 1) may generate a control signal 134 (FIG. 1), which may be configured to trigger the controllable load circuitry 136 (FIG. 1) to deactivate the artificial load setting corresponding to the Tx start event based on the expiration of the timeout period, e.g., as described above.

In some demonstrative aspects, as indicated at block 628, the method may include deactivating the artificial load setting corresponding to the Tx start event. For example, controllable load circuitry 136 (FIG. 1) may deactivate the artificial load setting corresponding to the Tx start event, e.g., as described above.

In some demonstrative aspects, as indicated at block 630, the method may include identifying an end of the packet Tx operation. For example, integrated circuit 110 (FIG. 1) may identify the end of the packet Tx operation.

In some demonstrative aspects, as indicated at block 632, the method may include generating a Tx end event indication, for example, based on a determination of an end of the packet Tx operation. For example, integrated circuit 110 (FIG. 1) may generate an indication signal 120 (FIG. 1), which may be configured to indicate the Tx end event to controller 132 (FIG. 1), e.g., as described above.

In some demonstrative aspects, as indicated at block 634, the method may include triggering the generation of an artificial load corresponding to the Tx end event. For example, controller 132 (FIG. 1) may generate a control signal 134 (FIG. 1), which may be configured to trigger the controllable load circuitry 136 (FIG. 1) to apply the artificial load corresponding to the Tx end event, e.g., as described above.

In some demonstrative aspects, as indicated at block 636, the method may include applying the artificial load corresponding to the Tx end event. For example, controllable load circuitry 136 (FIG. 1) may gradually apply the artificial load corresponding to the Tx end event, e.g., as described above.

In some demonstrative aspects, as indicated at blocks 638 and 640, the method may include maintaining the artificial load corresponding to the Tx end event for a predefined timeout period, and triggering deactivation of the artificial load corresponding to the Tx end event based on the expiration of the timeout period. For example, controller 132 (FIG. 1) may generate a control signal 134 (FIG. 1), which may be configured to trigger the controllable load circuitry 136 (FIG. 1) to deactivate the artificial load corresponding to the Tx end event based on the expiration of the timeout period, e.g., as described above.

In some demonstrative aspects, as indicated at block 642, the method may include deactivating the artificial load corresponding to the Tx end event. For example, controllable load circuitry 136 (FIG. 1) may gradually deactivate the artificial load corresponding to the Tx end event, e.g., as described above.

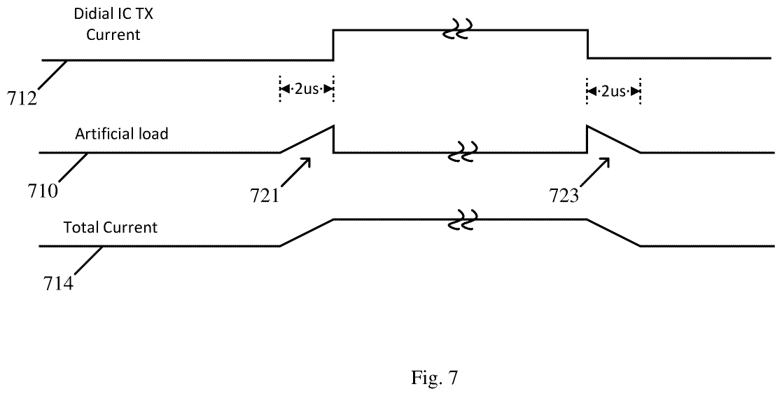

Reference is made to FIG. 7, which schematically illustrates a timing diagram depicting an artificial load current 710 configured based on a current consumption 712 of transmit circuitry, in accordance with some demonstrative aspects.

For example, a load controller, e.g., load controller 132 (FIG. 1) and/or load controller 232 (FIG. 2), may be configured to control activation of load circuitry, e.g., load circuitry 136 (FIG. 1) and/or load circuitry 236 (FIG. 2), to apply to a power supply, e.g., the power supply 170 (FIG. 1) and/or the power supply 270 (FIG. 2), an artificial load, which may result in the artificial load current 710.

For example, the load controller, e.g., load controller 132 (FIG. 1) and/or load controller 232 (FIG. 2), may be configured to control activation of the load circuitry, e.g., load circuitry 136 (FIG. 1) and/or load circuitry 236 (FIG. 2), to apply the artificial load resulting in the artificial load current 710, for example, based on the current consumption 712, which may be applied by an integrated circuit, e.g., integrated circuitry 110 (FIG. 1) and/or integrated circuitry 210 (FIG. 2).

In some demonstrative aspects, as shown in FIG. 7, the load controller, e.g., load controller 132 (FIG. 1) and/or load controller 232 (FIG. 2), may control, trigger, and/or cause the artificial load, e.g., load circuitry 136 (FIG. 1) and/or load circuitry 236 (FIG. 2), to apply the predefined artificial load 710 with a predefined load profile 721 during a predefined time, e.g., about 2 usec or any other suitable time period, prior to a start of a packet transmission.

In some demonstrative aspects, as shown in FIG. 7, the predefined load profile 721 may be configured to smooth out the relatively sharp transition in the current consumption 712 at the beginning of the packet transmission.

In some demonstrative aspects, as shown in FIG. 7, the load controller, e.g., load controller 132 (FIG. 1) and/or load controller 232 (FIG. 2), may be configured to trigger, cause and/or control the artificial load, e.g., load circuitry 136 (FIG. 1) and/or load circuitry 236 (FIG. 2), to apply to the power supply of the IC, e.g., the power supply 170 (FIG. 1) of IC 110 (FIG. 1) and/or the power supply 270 (FIG. 2) of IC 210 (FIG. 2), the predefined load profile 721, which may be configured, for example, to provide a smoother transition in a conjunction current 714, which may be based on conjunction of the artificial load current consumption 710, e.g., resulting from the artificial load, and the natural digital logic circuit current consumption 712 of the IC at the beginning of the packet transmission.

In some demonstrative aspects, as shown in FIG. 7, the load controller, e.g., load controller 132 (FIG. 1) and/or load controller 232 (FIG. 2), may control, trigger, and/or cause the artificial load, e.g., load circuitry 136 (FIG. 1) and/or load circuitry 236 (FIG. 2), to apply the predefined artificial load 710 with a predefined load profile 723 during a predefined time, e.g., about 2 usec or any other suitable time period, at an end of the packet transmission.

In some demonstrative aspects, as shown in FIG. 7, the predefined load profile 723 may be configured to smooth out the relatively sharp transition in the current consumption 712 at the end of the packet transmission.

In some demonstrative aspects, as shown in FIG. 7, the load controller, e.g., load controller 132 (FIG. 1) and/or load controller 232 (FIG. 2), may be configured to trigger, cause and/or control the artificial load, e.g., load circuitry 136 (FIG. 1) and/or load circuitry 236 (FIG. 2), to apply to the power supply of the IC, e.g., the power supply 170 (FIG. 1) of IC 110 (FIG. 1) and/or the power supply 270 (FIG. 2) of IC 210 (FIG. 2), the predefined load profile 723, which may be configured, for example, to provide a smoother transition in the conjunction current 714, which may be based on conjunction of the artificial load current consumption 710, e.g., resulting from the artificial load, and the natural digital logic circuit current consumption 712 of the IC at the end of the packet transmission.

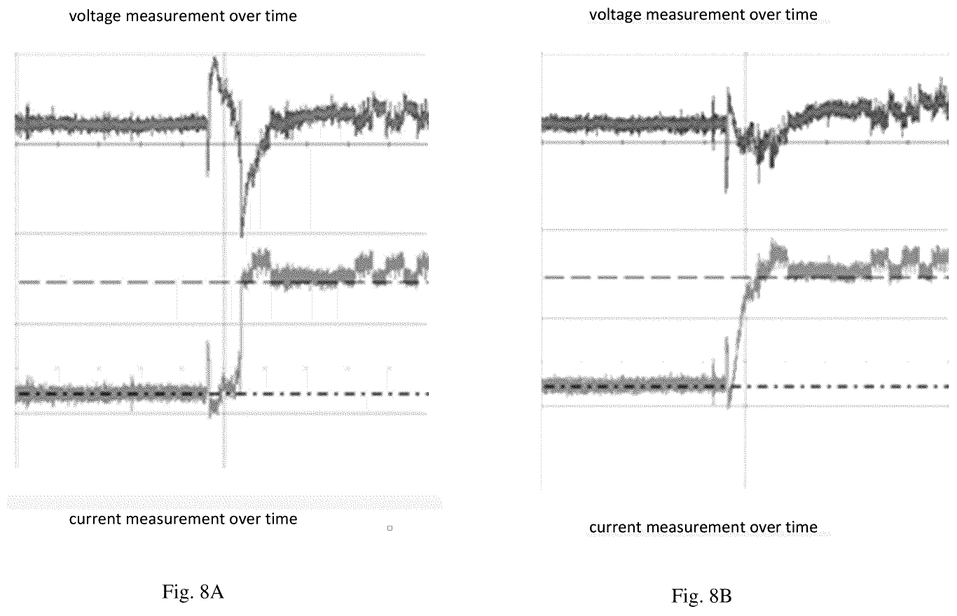

Reference is made to FIG. 8A, which illustrates a graph depicting voltage and current versus time for wireless transmission circuitry, and to FIG. 8B which illustrates a graph depicting voltage and current versus time for the wireless transmission circuitry subject to current consumption adjustment by an artificial load, in accordance with some demonstrative aspects.

For example, the graph of FIG. 8A may be based on simulation results corresponding to the voltage and current consumption applied by a wireless transmission circuitry, e.g., integrated circuit 110 (FIG. 1), to a power supply, e.g., power supply 170 (FIG. 1), for example, at a packet Tx operation.

For example, the graph of FIG. 8B may be based on simulation results corresponding to the voltage and current consumption applied to the power supply, e.g., power supply 170 (FIG. 1), for example, when current consumption adjuster 130 (FIG. 1) is implemented to apply the artificial load at the packet Tx operation, e.g., as described above.

For example, as shown in FIG. 8A, the wireless transmission circuitry may cause, for example, during a start of a transmission, a relatively large and fast current transient, which may reach, for example, 1.4 A, e.g., within 100 nsec. This current transient may be caused, for example, due to a need to support real time processing and/or enabling or disabling number of functional units in parallel.

For example, as shown in FIG. 8B, current consumption adjuster 130 (FIG. 1) may be implemented to apply an artificial load, which may be configured to smoothen the effective 1.4 A transition, e.g., to a longer time period, e.g., to 2.1 usec. For example, this resulting lower load may be successfully cared by a PDN, e.g., an external PDN, and/or the power supply, e.g., with acceptable overshoot and/or undershoot.

For example, as shown in FIG. 8B, the implementation of the current consumption adjuster 130 (FIG. 1) may provide a technical solution to substantially reduce an overshoot and undershoot swing, for example, by up to about 50%, e.g., for some scenarios.

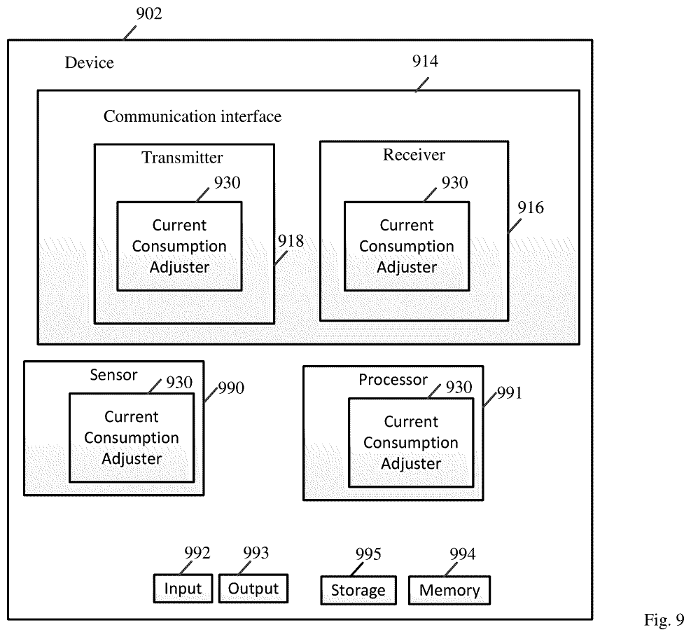

Reference is now made to FIG. 9, which schematically illustrates a block diagram of a device 902, in accordance with some demonstrative aspects.

In some demonstrative aspects, device 902 may include a wireless communication device, and/or a wired communication device.

In some demonstrative aspects, device 902 may include, for example, a computing device, an MD, a STA, a PC, a desktop computer, a mobile computer, a laptop computer, an Ultrabook™ computer, a Smartphone, a gaming device, a peripheral device, a notebook computer, a tablet computer, a handheld computer, an Internet of Things (IoT) device, a sensor device, a handheld device, a wearable device, an on-board device, an off-board device, a consumer device, a vehicular device, a non-vehicular device, a mobile or portable device, a non-mobile or non-portable device, a mobile phone, a cellular telephone, a video device, an audio device, an A/V device, a video source, an audio source, a video sink, an audio sink, a Personal Media Player (PMP), a digital audio player, a data source, a data sink, a media player, or the like.

In some demonstrative aspects, device 902 may include, operate as, and/or perform the functionality of, a WLAN STA.

In some demonstrative aspects, device 902 may include, operate as, and/or perform the functionality of, a Wi-Fi STA.

In some demonstrative aspects, device 902 may include, operate as, and/or perform the functionality of, a BT device.

In some demonstrative aspects, device 902 may include, operate as, and/or perform the functionality of, one or more cellular client devices.

In other aspects, device 902 may include, operate as, and/or perform the functionality of any other type of computing device, communication device, and/or any other device.

In some demonstrative aspects, device 902 may include, for example, one or more of a processor 991, an input unit 992, an output unit 993, a memory unit 994, and/or a storage unit 995. Device 902 may optionally include other suitable hardware components and/or software components. In some demonstrative aspects, some or all of the components of device 902 may be enclosed in a common housing or packaging, and may be interconnected or operably associated using one or more wired or wireless links. In other aspects, components of device 902 may be distributed among multiple or separate devices.

In some demonstrative aspects, processor 991 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 991 executes instructions, for example, of an Operating System (OS) of device 902 and/or of one or more suitable applications.

In some demonstrative aspects, input unit 992 may include, for example, a keyboard, a keypad, a mouse, a touch-screen, a touch-pad, a track-ball, a stylus, a microphone, or other suitable pointing device or input device. Output unit 993 includes, for example, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 994 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 995 includes, for example, a hard disk drive, a Solid State Drive (SSD), and/or other suitable removable or non-removable storage units. Memory unit 994 and/or storage unit 995, for example, may store data processed by device 902.

In some demonstrative aspects, device 902 may be capable of communicating content, data, information and/or signals via a communication medium, e.g., a wireless medium or a wired medium.

In some demonstrative aspects, the wireless medium may include, for example, a radio channel, a cellular channel, an RF channel, a WiFi channel, a BT channel, an IR channel, and the like.

In some demonstrative aspects, device 902 may include one or more radios and or communication interfaces including circuitry and/or logic to perform communication between device 902 and/or one or more other devices. For example, device 902 may include at least one communication interface 914.

In some demonstrative aspects, communication interface 914 may include, for example, a WiFi radio, a cellular radio, a BT radio, and/or the like.

In some demonstrative aspects, communication interface 914 may include one or more receivers (Rx) including circuitry and/or logic to receive wireless communication signals, RF signals, frames, blocks, transmission streams, packets, messages, data items, and/or data. For example, communication interface 914 may include at least one receiver 916.

In some demonstrative aspects, communication interface 914 may include one or more transmitters (Tx) including circuitry and/or logic to transmit wireless communication signals, RF signals, frames, blocks, transmission streams, packets, messages, data items, and/or data. For example, communication interface 914 may include at least one transmitter 918.

In some demonstrative aspects, communication interface 914, transmitter 918, and/or receiver 916 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, device 902 may include, for example, at least one sensor 990, for example, an image sensor, and/or any other suitable type of sensor.

In some demonstrative aspects, as shown in FIG. 9, one or more elements of device 902 may include a current consumption adjuster 930, which may be configured to adjust and/or control a current consumption from a power supply of one or more integrated circuits, e.g., as described above.

In some demonstrative aspects, as shown in FIG. 9, communication interface 914, transmitter 918, and/or receiver 916 may include a current consumption adjuster 930, which may be configured to adjust and/or control a current consumption from a power supply of one or more wireless communication integrated circuits, e.g., as described above.

In some demonstrative aspects, as shown in FIG. 9, processor 991 may include a current consumption adjuster 930, which may be configured to adjust and/or control a current consumption from a power supply of one or more processor integrated circuits, e.g., as described above.

In some demonstrative aspects, as shown in FIG. 9, sensor 990 may include a current consumption adjuster 930, which may be configured to adjust and/or control a current consumption from a power supply of one or more sensor integrated circuits, e.g., as described above.

In some demonstrative aspects, current consumption adjuster 930 may include one or more elements of current consumption adjuster 130 (FIG. 1), and/or may perform one or more operations and/or functionalities of current consumption adjuster 130 (FIG. 1), e.g., as described above.

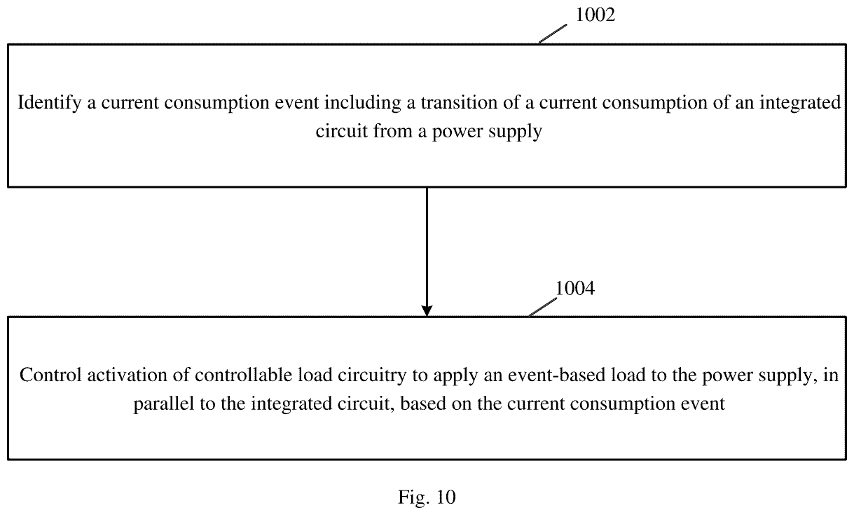

Reference is made to FIG. 10, which illustrates a method of current consumption adjustment, in accordance with some demonstrative aspects. For example, one or more of the operations of the method of FIG. 10 may be performed by a current consumption adjuster, e.g., current consumption adjuster 130 (FIG. 1) and/or current consumption adjuster 230 (FIG. 2), a controller, e.g., controller 132 (FIG. 1) and/or controller 232 (FIG. 2), and/or controllable load circuitry, e.g., controllable load circuitry 136 (FIG. 1) and/or controllable load circuitry 236 (FIG. 2).

In some demonstrative aspects, as indicated at block 1002, the method may include identifying a current consumption event including a transition of a current consumption of an integrated circuit from a power supply. For example, controller 132 (FIG. 1) may be configured to identify the current consumption event including a transition of a current consumption of the integrated circuit 110 (FIG. 1) from the power supply 170 (FIG. 1), e.g., as described above.

In some demonstrative aspects, as indicated at block 1004, the method may include controlling activation of controllable load circuitry to apply an event-based load to the power supply, e.g., in parallel to the integrated circuit, for example, based on the current consumption event. For example, controller 132 (FIG. 1) may be configured to control activation of controllable load circuitry 136 (FIG. 1) to apply an event-based load to the power supply 160 (FIG. 1), e.g., in parallel to the integrated circuit 110 (FIG. 1), for example, based on the current consumption event, e.g., as described above.

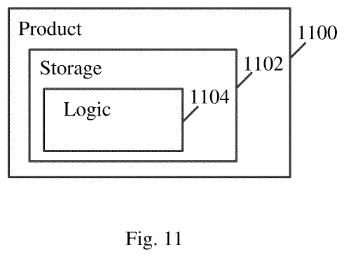

Reference is made to FIG. 11, which schematically illustrates a product of manufacture 1100, in accordance with some demonstrative aspects. Product 1100 may include one or more tangible computer-readable (“machine-readable”) non-transitory storage media 1102, which may include instructions, e.g., implemented by logic 1104, operable to, when executed by at least one processor, enable the at least one processor to implement one or more operations and/or functionalities described with reference to the FIGS. 1-10, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1100 and/or machine-readable storage media 1102 may include one or more types of computer-readable storage media capable of storing data, including volatile memory, non-volatile memory, removable or non-removable memory, erasable or non-erasable memory, writeable or re-writeable memory, and the like. For example, machine-readable storage media 1102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a current consumption adjuster to adjust a current consumption from a power supply of an integrated circuit, the current consumption adjuster comprising controllable load circuitry to controllably apply one or more loads to the power supply, e.g., in parallel to the integrated circuit; and a controller configured to identify a current consumption event comprising a transition of a current consumption of the integrated circuit from the power supply, and to control activation of the controllable load circuitry to apply an event-based load to the power supply based on the current consumption event.

Example 2 includes the subject matter of Example 1, and optionally, wherein the controller is configured to determine a load period based on the current consumption event, and to control the controllable load circuitry to apply the event-based load during the load period.

Example 3 includes the subject matter of Example 2, and optionally, wherein the controller is configured to determine the load period to begin prior to the transition of the current consumption of the integrated circuit based on a determination that the transition of the current consumption of the integrated circuit comprises an increase of the current consumption of the integrated circuit.

Example 4 includes the subject matter of Example 2 or 3, and optionally, wherein the controller is configured to determine the load period to begin at or after the transition of the current consumption of the integrated circuit based on a determination that the transition of the current consumption of the integrated circuit comprises a decrease of the current consumption of the integrated circuit.

Example 5 includes the subject matter of any one of Examples 2-4, and optionally, wherein the controller is configured to control the controllable load circuitry to apply the event-based load comprising a monotonically changing load magnitude during the load period.

Example 6 includes the subject matter of any one of Examples 2-5, and optionally, wherein the controller is configured to control the controllable load circuitry to apply the event-based load comprising a monotonically increasing load magnitude during the load period based on a determination that the transition of the current consumption of the integrated circuit comprises an increase of the current consumption of the integrated circuit.

Example 7 includes the subject matter of any one of Examples 2-6, and optionally, wherein the controller is configured to control the controllable load circuitry to apply the event-based load comprising a monotonically decreasing load magnitude during the load period based on a determination that the transition of the current consumption of the integrated circuit comprises a decrease of the current consumption of the integrated circuit.

Example 8 includes the subject matter of any one of Examples 1-7, and optionally, wherein the controller is configured to control the controllable load circuitry to apply the event-based load configured to result in an adjusted transition of the current consumption from the power supply, wherein the adjusted transition of the current consumption from the power supply is based on a combination of the transition of the current consumption of the integrated circuit and a load-based current consumption of the event-based load.

Example 9 includes the subject matter of Example 8, and optionally, wherein the transition of the current consumption of the integrated circuit comprises a first transition from a first current to a second current within a first transition period, wherein the adjusted transition of the current consumption from the power supply comprises a second transition from the first current to the second current within a second transition period, wherein the second transition period is longer than the first transition period.

Example 10 includes the subject matter of Example 9, and optionally, wherein the first transition period is less than 500 nanoseconds, and the second transition period is longer than 1 microsecond.

Example 11 includes the subject matter of Example 9 or 10, and optionally, wherein the second transition period is at least 10 times longer than the first transition period.

Example 12 includes the subject matter of any one of Examples 9-11, and optionally, wherein an absolute difference between the first current and the second current is at least 0.5 Ampere.

Example 13 includes the subject matter of any one of Examples 9-12, and optionally, wherein an absolute difference between the first current and the second current is at least 1 Ampere.

Example 14 includes the subject matter of any one of Examples 1-13, and optionally, wherein the controllable load circuitry comprises a plurality of load banks, e.g., parallel load banks, configured to provide a respective plurality of loads, wherein the controller is configured to selectively activate one or more load banks of the plurality of load banks, e.g., parallel load banks, according to the event-based load to be applied to the power supply based on the current consumption event.

Example 15 includes the subject matter of Example 14, and optionally, wherein the plurality of load banks, e.g., parallel load banks, comprises at least two different load banks to provide at least two respective different loads.

Example 16 includes the subject matter of Example 14 or 15, and optionally, wherein the plurality of load banks, e.g., parallel load banks, comprises at least two equal load banks to provide a same load.

Example 17 includes the subject matter of any one of Examples 14-16, and optionally, wherein a load bank comprises one or more bank cells, wherein a bank cell comprises a plurality of load cells.

Example 18 includes the subject matter of any one of Examples 1-17, and optionally, wherein the current consumption adjuster is configured to adjust the current consumption from the power supply based on current consumption events corresponding to a plurality of integrated circuits, e.g., in parallel to the power supply.

Example 19 includes the subject matter of Example 18, and optionally, wherein the controller is configured to identify a plurality of at least partially-overlapping current consumption events comprising a first current consumption event corresponding to a first integrated circuit and a second current consumption event corresponding to a second integrated circuit, wherein the second current consumption event at least partially overlaps in time with the first current consumption event, wherein the controller is configured to control activation of the controllable load circuitry to apply the event-based load based on the plurality of at least partially-overlapping current consumption events.

Example 20 includes the subject matter of any one of Examples 1-19, and optionally, wherein the controller is configured to determine based on the current consumption event at least one of a timing of the event-based load, a load magnitude of the event-based load, a load duration of the event-based load, a slew rate of the event-based load, a start time of the event-based load, or an end time of the event-based load.

Example 21 includes the subject matter of any one of Examples 1-20, and optionally, wherein the controller is configured to identify the current consumption event based on an event indication from the integrated circuit.

Example 22 includes the subject matter of any one of Examples 1-21, and optionally, wherein the controllable load circuitry is configured to apply the event-based load to the power supply within a response time of less than 100 nanoseconds.

Example 23 includes the subject matter of any one of Examples 1-22, and optionally, wherein the controllable load circuitry is configured to apply the event-based load to the power supply within a response time of 50 nanoseconds or less.

Example 24 includes the subject matter of any one of Examples 1-23, and optionally, comprising a chip comprising the integrated circuit and the current consumption adjuster.

Example 25 includes the subject matter of any one of Examples 1-23, and optionally, comprising a chip comprising the power supply and the current consumption adjuster.

Example 26 includes the subject matter of any one of Examples 1-25, and optionally, wherein the integrated circuit comprises a wireless communication integrated circuit to process communication of wireless communication signals.

Example 27 includes the subject matter of any one of Examples 1-26, and optionally, wherein the integrated circuit comprises a transmitter integrated circuit to process transmission of a wireless communication signal.

Example 28 includes the subject matter of any one of Examples 1-27, and optionally, wherein the integrated circuit comprises a receiver integrated circuit to process reception of a wireless communication signal.

Example 29 includes the subject matter of any one of Examples 1-28, and optionally, wherein the integrated circuit comprises a Very Large-Scale Integration (VLSI) circuit.

Example 30 comprises a computing device comprising the apparatus of any one of Examples 1-29.

Example 31 comprises a wireless communication device comprising the apparatus of any one of Examples 1-29.

Example 32 comprises an apparatus comprising means for executing any of the described operations of Examples 1-29.

Example 33 comprises a product comprising one or more tangible computer-readable non-transitory storage media comprising instructions operable to, when executed by at least one processor, enable the at least one processor to cause a device to perform any of the described operations of Examples 1-29.

Example 34 comprises an apparatus comprising: a memory interface; and processing circuitry configured to: perform any of the described operations of Examples 1-29.

Example 35 comprises a method comprising any of the described operations of Examples 1-29.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a current consumption adjuster to adjust a current consumption from a power supply of an integrated circuit, the current consumption adjuster comprising:
controllable load circuitry to controllably apply one or more loads to the power supply of the integrated circuit; and
a controller configured to identify a current consumption event comprising a transition of a current consumption of the integrated circuit from the power supply, and to control activation of the controllable load circuitry to apply an event-based load to the power supply based on the current consumption event.

2. The apparatus of claim 1, wherein the controller is configured to determine a load period based on the current consumption event, and to control the controllable load circuitry to apply the event-based load during the load period.

3. The apparatus of claim 2, wherein the controller is configured to determine the load period to begin prior to the transition of the current consumption of the integrated circuit based on a determination that the transition of the current consumption of the integrated circuit comprises an increase of the current consumption of the integrated circuit.

4. The apparatus of claim 2, wherein the controller is configured to determine the load period to begin at or after the transition of the current consumption of the integrated circuit based on a determination that the transition of the current consumption of the integrated circuit comprises a decrease of the current consumption of the integrated circuit.

5. The apparatus of claim 2, wherein the controller is configured to control the controllable load circuitry to apply the event-based load comprising a monotonically changing load magnitude during the load period.

6. The apparatus of claim 2, wherein the controller is configured to control the controllable load circuitry to apply the event-based load comprising a monotonically increasing load magnitude during the load period based on a determination that the transition of the current consumption of the integrated circuit comprises an increase of the current consumption of the integrated circuit.

7. The apparatus of claim 2, wherein the controller is configured to control the controllable load circuitry to apply the event-based load comprising a monotonically decreasing load magnitude during the load period based on a determination that the transition of the current consumption of the integrated circuit comprises a decrease of the current consumption of the integrated circuit.

8. The apparatus of claim 1, wherein the controller is configured to control the controllable load circuitry to apply the event-based load configured to result in an adjusted transition of the current consumption from the power supply, wherein the adjusted transition of the current consumption from the power supply is based on a combination of the transition of the current consumption of the integrated circuit and a load-based current consumption of the event-based load.

9. The apparatus of claim 8, wherein the transition of the current consumption of the integrated circuit comprises a first transition from a first current to a second current within a first transition period, wherein the adjusted transition of the current consumption from the power supply comprises a second transition from the first current to the second current within a second transition period, wherein the second transition period is longer than the first transition period.

10. The apparatus of claim 9, wherein the first transition period is less than 500 nanoseconds, and the second transition period is longer than 1 microsecond.

11. The apparatus of claim 9, wherein an absolute difference between the first current and the second current is at least 0.5 Ampere.

12. The apparatus of claim 1, wherein the controllable load circuitry comprises a plurality of parallel load banks configured to provide a respective plurality of loads, wherein the controller is configured to selectively activate one or more load banks of the plurality of parallel load banks according to the event-based load to be applied to the power supply based on the current consumption event.

13. The apparatus of claim 1, wherein the current consumption adjuster is configured to adjust the current consumption from the power supply based on current consumption events corresponding to a plurality of integrated circuits in parallel to the power supply.

14. The apparatus of claim 13, wherein the controller is configured to identify a plurality of at least partially-overlapping current consumption events comprising a first current consumption event corresponding to a first integrated circuit and a second current consumption event corresponding to a second integrated circuit, wherein the second current consumption event at least partially overlaps in time with the first current consumption event, wherein the controller is configured to control activation of the controllable load circuitry to apply the event-based load based on the plurality of at least partially-overlapping current consumption events.

15. The apparatus of claim 1, wherein the controller is configured to determine based on the current consumption event at least one of a timing of the event-based load, a load magnitude of the event-based load, a load duration of the event-based load, a slew rate of the event-based load, a start time of the event-based load, or an end time of the event-based load.

16. The apparatus of claim 1, wherein the controller is configured to identify the current consumption event based on an event indication from the integrated circuit.

17. The apparatus of claim 1, wherein the controllable load circuitry is configured to apply the event-based load to the power supply within a response time of less than 100 nanoseconds.

18. The apparatus of claim 1, wherein the integrated circuit comprises a wireless communication integrated circuit to process communication of wireless communication signals.

19. A wireless communication device comprising:
one or more antennas;
a wireless communication interface to communicate wireless communication signals via the one or more antennas, the wireless communication interface comprising an integrated circuit;
a processor to process data based on the wireless communication signals;
a power supply to provide power to the integrated circuit; and
a current consumption adjuster to adjust a current consumption from the power supply, the current consumption adjuster comprising:
controllable load circuitry to controllably apply one or more loads to the power supply of the integrated circuit; and
a controller configured to identify a current consumption event comprising a transition of a current consumption of the integrated circuit from the power supply, and to control activation of the controllable load circuitry to apply an event-based load to the power supply based on the current consumption event.

20. The wireless communication device of claim 19, wherein the controller is configured to determine a load period based on the current consumption event, and to control the controllable load circuitry to apply the event-based load during the load period.
